(19) United States
(12) Patent Application Publication
(10) Pub. No.: US 2015/0303745 A1
(43) Pub. Date: Oct. 22, 2015

(54) Axial Gap Motor

(71) Applicant: Hitachi, Ltd., Chiyoda-ku, Tokyo (JP)

(72) Inventor: Hironori MATSUMOTO, Tokyo (JP)

(21) Appl. No.: 14/647,880

(22) PCT Filed: Oct. 9, 2013
(86) PCT No.: PCT/JP2013/077415

§ 371 Date: May 28, 2015

(30) Foreign Application Priority Data
Dec. 7, 2012 (JP) 2012-268141

(51) Int. Cl. H02K 1/18; H02K 9/22; H02K 1/14

(52) U.S. Cl. CPC H02K 1/182; H02K 1/14; H02K 9/22

(57) ABSTRACT

To provide an axial gap motor with higher reliability that may prevent displacement of iron core pieces at temperature rise and may be easily manufactured to be lighter. An axial gap motor 100 includes a rotor 30, a stator 20 in which a plurality of iron core pieces 1 wound with coils 9 are arranged in a circumferential direction, a case 3 housing the rotor 30 and the stator 20. The stator 20 and the rotor 30 are coaxially provided with an air gap G in between. The stator 20 has a conducting material 2 provided to be in contact with end parts of the iron core pieces 1 in an axis direction and fixed to the case 3. The stator 20 is integrally molded using a resin material 4 to contain the coils 9, the iron core pieces 1, and the conducting material 2 inside, and thereby, fixed to the case 3.

### TECHNICAL FIELD

This invention relates to an axial gap motor.

### BACKGROUND ART

In related art, axial gap motors including disk-shaped stators and disk-shaped rotors are known. In the axial gap motor, because of its structure, the length in an axis (shaft) direction, i.e., the thickness of the axial gap motor may be made thinner. Accordingly, the axial gap motors are heavily used in locations where flat motors may be provided.

As a method of holding the stator of the axial gap motor, in view of ease of manufacturing, a method of fixing the stator by a resin material with advantageous mechanical property, insulation property, heat resistance, etc. and bonding and fixing the stator to another structure member such as a case (housing) is known (for example, see PTL 1).

Further, as another method, a method of providing a plate-like support member to divide a coil, and thereby, holding an iron core piece of the stator is known (for example, see PTL 2).

### CITATION LIST

### Patent Literature

### PTL 1: JP-A-2007-104795

PTL 2: JP-A-2005-269778

### SUMMARY OF INVENTION

### Technical Problems

However, in PTL 1, the resin material is selected as the method of holding the stator, but it is difficult to strongly hold the iron core by the resin material alone. That is, on the assumption that the resin material is deteriorated due to the temperature rise of the motor and the ambient temperature for use, the method lacks reliability.

Further, generally, the resin material turns to a rubber state at a temperature of glass transition or higher, and its rigidity becomes extremely lower. As a result, the iron core pieces move due to the weights of the iron core pieces and relative displacement of the iron core pieces is concerned.

The above described phenomenon prominently appears due to temperature rise by heating and heat generation at curing, for example. Accordingly, it is difficult that the phenomenon becomes an issue in a structure gradually heated and cooled while being held by a die or the like. However, for example, in the case where a process of rapidly heating and cooling is required for increase in productivity, when the related art disclosed in PTL 1 is used, the issue is difficult to be solved.

On the other hand, in PTL 2, the iron core pieces are fixed only by the same material as that of the case (conducting material), and a holding force of the iron core pieces with the higher strength may be obtained compared to that in the case of using the resin material.

However, in the configuration, the usage of the conducting material increases and the motor weight also increases. Further, the coil is divided in two, and there is an issue in manufacturing.

An object of the invention is to provide an axial gap motor with higher reliability that may prevent displacement of iron core pieces at temperature rise and may be easily manufactured to be lighter.

### Solution to Problems

In order to achieve the object, an axial gap motor of the invention includes a rotor, a stator in which a plurality of iron core pieces wound with coils are arranged in a circumferential direction, a case housing the rotor and the stator, wherein the stator and the rotor are coaxially provided with an air gap in between, the stator has a conducting material provided to be in contact with end parts of the iron core pieces in an axis direction and fixed to the case, and is integrally molded using a resin material to contain the coils, the iron core pieces, and the conducting material inside, and thereby, fixed to the case.

### Advantageous Effects of Invention

According to the invention, the axial gap motor with higher reliability in which displacement of iron core pieces at temperature rise is prevented may be easily manufactured to be lighter. The other problems, configurations, and advantageous effects than those described above will be clear by the following explanation of embodiments.

### BRIEF DESCRIPTION OF DRAWINGS

FIG. 1 is a perspective view of an axial gap motor as the first embodiment of the invention.

FIG. 2 is a sectional view of the axial gap motor as the first embodiment of the invention.

FIG. 3 is a perspective view of a stator used for the axial gap motor as the first embodiment of the invention.

FIG. 4 is a configuration diagram of the stator used for the axial gap motor as the first embodiment of the invention.

FIG. 5 is a sectional view of the stator used for the axial gap motor as the first embodiment of the invention shown in FIG. 4.

FIG. 6 is a sectional view of an axial gap motor of a first related art example.

FIG. 7 is a sectional view of an axial gap motor of a second related art example.

FIG. 8 is a configuration diagram of a stator used for an axial gap motor as the second embodiment of the invention.

FIG. 9 is a sectional view of the axial gap motor as the second embodiment of the invention shown in FIG. 8.

FIG. 10 is a sectional view of a stator used for an axial gap motor as the third embodiment of the invention.

FIG. 11 is a configuration diagram of a stator used for an axial gap motor as the fourth embodiment of the invention.

FIG. 12 is a sectional view of the axial gap motor as the fourth embodiment of the invention shown in FIG. 11.

FIG. 13 is a configuration diagram of a stator used for an axial gap motor as the fifth embodiment of the invention.

FIG. 14 is a sectional view of the axial gap motor as the fifth embodiment of the invention shown in FIG. 13.

FIG. 15 is a sectional view of a stator used for an axial gap motor as the sixth embodiment of the invention.

FIG. 16 is a configuration diagram of a stator used for an axial gap motor as the seventh embodiment of the invention.

FIG. 17 is a top view of the stator used for the axial gap motor as the seventh embodiment shown in FIG. 16.

FIG. 18 is a configuration diagram of a stator used for an axial gap motor as the eighth embodiment of the invention.

FIG. 19 is a top view (schematic view) of the stator used for the axial gap motor as the eighth embodiment shown in FIG. 18.

### DESCRIPTION OF EMBODIMENTS

### First Embodiment

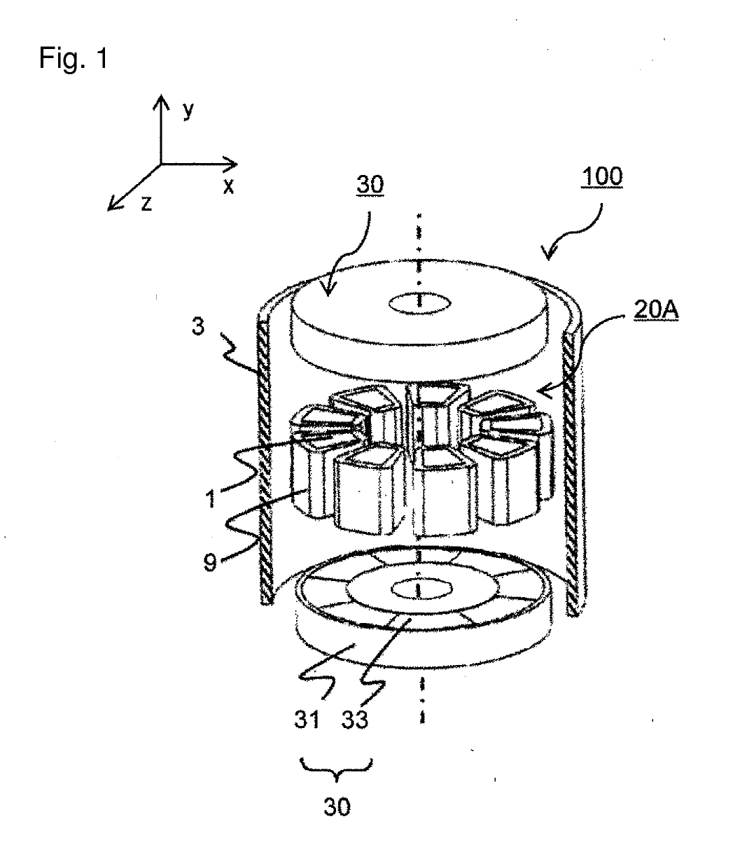

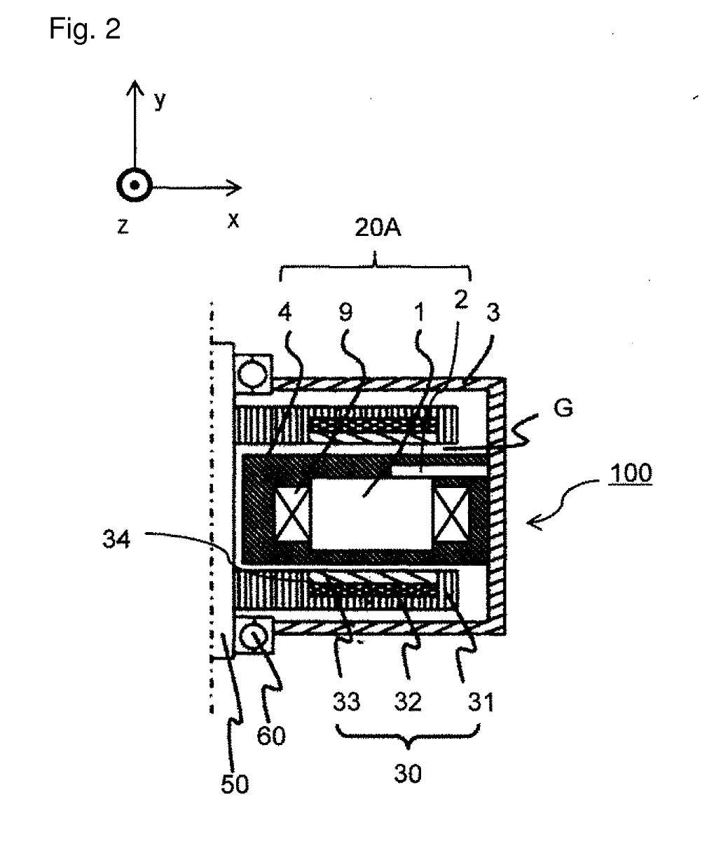

As below, a configuration and an operation of an axial gap motor as the first embodiment of the invention will be explained using FIGS. 1 and 2.

First, the overall configuration of the axial gap motor will be explained using FIG. 1. FIG. 1 is a perspective view of an axial gap motor 100 as the first embodiment of the invention.

The axial gap motor 100 includes a case 3, a disk-shaped stator 20A, and two disk-shaped rotors 30. In FIG. 1, the stator 20A is schematically shown for visibility of the drawing.

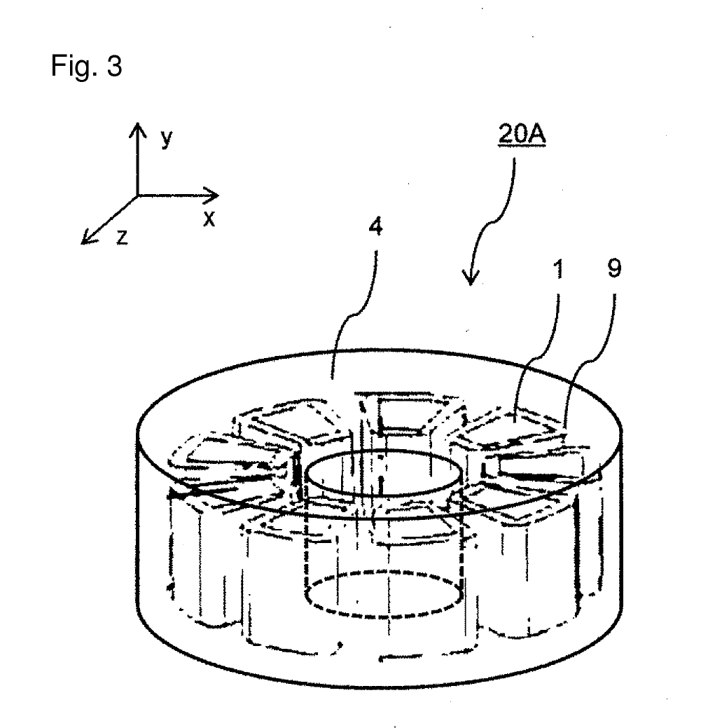

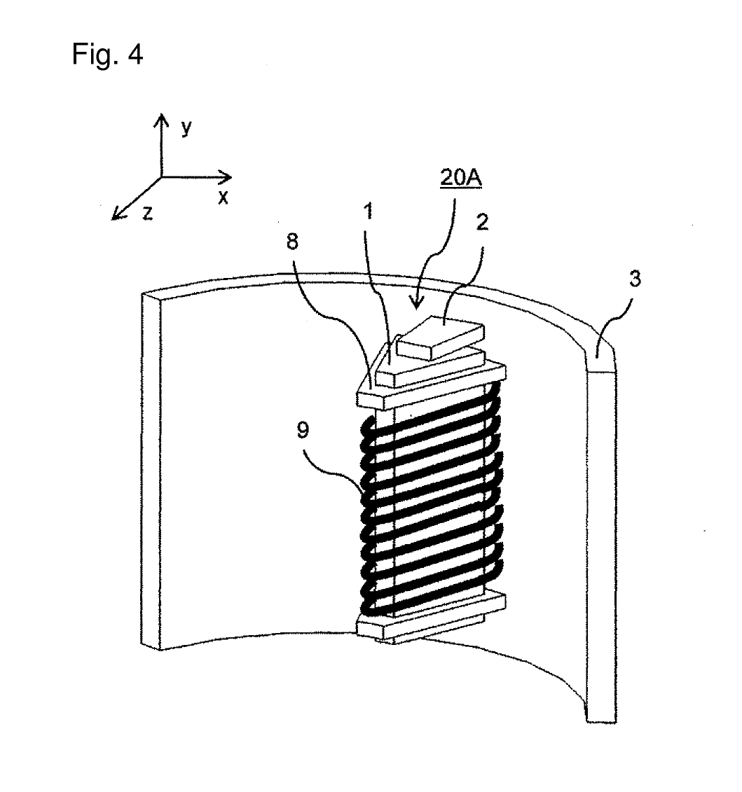

The stator 20A mainly includes iron core pieces 1 and coils 9. In FIG. 1, the nine iron core pieces 1 are arranged in the circumferential direction of the stator 20A at equal intervals. The details of the stator 20A will be described later using FIGS. 3 and 4.

The rotor 30 includes a disk-shaped structure member 31 and permanent magnets 33. The permanent magnets 33 are provided at the outer side in the radial direction of the structure member 31. In FIG. 1, the eight permanent magnets 33 are arranged in the circumferential direction at equal intervals. The polarity of the permanent magnets 33 alternately differs in the circumferential direction.

The case 3 houses the stator 20A and the rotors 30. The case 3 is formed using a metal such as aluminum die-casting.

Next, the configuration of the axial gap motor 100 will be explained using FIG. 2. FIG. 2 is a sectional view of the axial gap motor 100 as the first embodiment of the invention. Note that the same signs are assigned to the same parts as those in FIG. 1. Further, the sectional view is axially symmetric and FIG. 2 shows only the right half of the sectional view.

The stator 20A includes the iron core pieces 1, the coils 9 wound around the outer circumferences of the iron core pieces 1, and an aluminum conducting material 2 in contact with the upper ends of the iron core pieces 1. The conducting material 2 is pressed against the case 3 by a machine tool or the like and press-welded to the case 3. The stator 20A is integrally molded using a resin material 4 to contain these component elements inside.

Thereby, the stator 20A is fixed to the case 3 by the resin material 4 and the conducting material 2. The resin material 4 also functions as an adhesive agent for the stator 20A and the case 3. The iron core pieces 1 are held by the resin material 4 and the conducting material 2. Note that the iron core pieces 1 are formed by stacked magnetic steel sheets, an amorphous material, or the like.

The rotor 30 includes the disk-shaped structure member 31, a yoke 32, and the permanent magnets 33. The annular-shaped single yoke 32 is provided in a groove part 34 formed at the outer side in the radial direction of the structure member 31 and fixed. The eight permanent magnets 33 are provided in the circumferential direction with alternate polarity in the y-axis direction on the yoke 32 and fixed to the groove part 34. The pair of rotors 30 are fixed to a shaft 50 with a fixed gap in the axis direction (y-axis direction) of the shaft 50. The shaft 50 is rotatably supported by a bearing 60 provided in the case 3.

Here, the stator 20A is provided between the pair of rotors 30. An air gap G is formed between the stator 20A and the rotor 30. Thereby, the stator 20A and the rotor 30 are coaxially provided with the air gap G in between.

Subsequently, the operation of the axial gap motor 100 will be explained using FIG. 2.

When currents flow in the coils 9, the stator 20A generates a magnetic field in the axis direction (y-axis direction) of the shaft 50. On the other hand, the permanent magnets 33 of the rotors 30 also generate magnetic fields in the axis direction of the shaft 50. The currents flowing in the coils 9 are controlled so that the rotors 30 may rotate by the interaction between the magnetic field generated by the stator 20A and the magnetic fields generated by the rotors 30.

Next, the configuration of the stator 20A used for the axial gap motor as the first embodiment of the invention will be explained using FIGS. 3 to 5. Note that the same signs are assigned to the same parts as those in FIGS. 1 and 2.

First, the overall configuration of the stator 20A will be explained using FIG. 3. FIG. 3 is a perspective view of the stator 20A used for the axial gap motor 100 as the first embodiment of the invention. In FIG. 3, inside of the ring-shaped resin material 4, the nine iron core pieces 1 wound with the coils 9 are contained in the circumferential direction at equal intervals.

Here, as the resin material 4, a thermosetting resin may be used. The thermosetting resin is higher in heat resistance and mechanical strength and particularly preferable as the material for increasing the holding strength of the iron core pieces 1. Further, the thermosetting resin has lower molecular weight and lower viscosity when melted compared to a thermoplastic resin, and does not require high pressure at molding. Accordingly, injection pressure may be suppressed to be lower and deformation of the iron core pieces 1 and the conducting material 2 and wear of the die may be suppressed to be minimum.

As the thermosetting resin, epoxy resin is particularly preferable. The epoxy resin has higher heat resistance compared to the other thermosetting resins and lower viscosity at injection compared to the other thermosetting resins, and may protect the other members. Further, when the amine-based curing agent is used, not only that the curing time is shorter but also that adhesiveness is improved, and thereby, the fixation strength to the iron core pieces 1 and the case 3 may be improved. As a result, the holding strength of the iron core pieces 1 is improved.

Next, the configuration of the stator 20A will be explained in detail using FIG. 4. FIG. 4 is a configuration diagram of the stator 20A used for the axial gap motor 100 as the first embodiment of the invention. Note that, in FIG. 4, the resin material 4 is not shown for visibility of the drawing.

The stator 20A includes bobbins 8 formed using an insulating material, the iron core pieces 1 inserted into the bobbins 8, the coils 9 wound around the bobbins 8, and the plate-like conducting material 2 in contact with the upper ends of the iron core pieces 1. Note that the conducting material 2 may be fixed to the upper ends of the iron core pieces 1 by welding, pressure welding, or the like. The conducting material 2 is pressure-welded to the case 3. In the embodiment, the conducting material 2 is made of aluminum, however, may be a metal such as iron.

Here, an eddy-current loss in the conducting material 2 is problematic due to the influence of the magnetic field generated in the iron core pieces 1. Accordingly, it is desired that the conducting material 2 is formed by a structure or material that suppresses the eddy-current loss. As the structure, a slit in a direction of interruption of the eddy current, stacking in the perpendicular direction to the direction in which the eddy current flows, a thin plate, or the like may be taken as a preferable example. Further, in view of the material, an amorphous material, a conducting resin material with lower insulation resistance, or the like may be used.

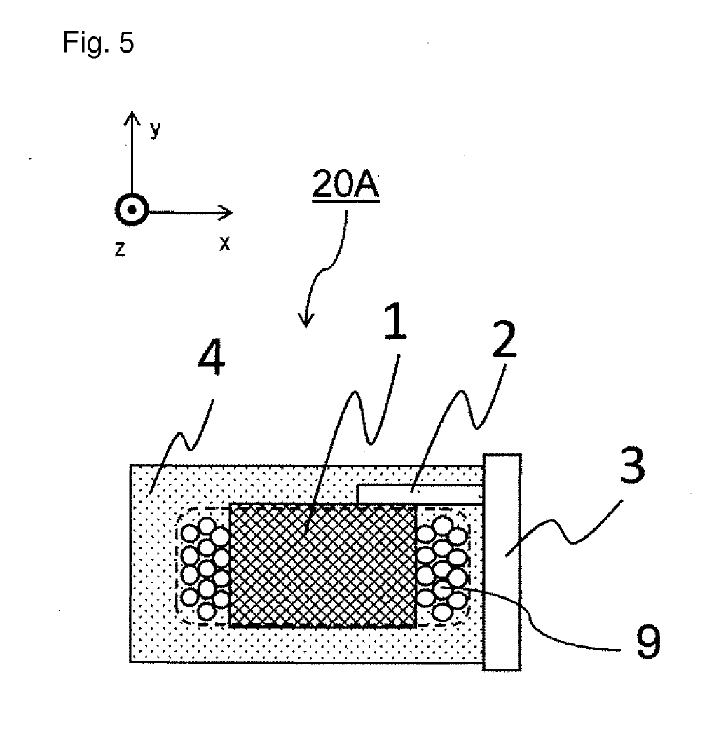

Next, the advantageous effect of the stator 20A used for the axial gap motor 100 as the first embodiment of the invention will be explained using FIG. 5. FIG. 5 is a sectional view of the stator 20A used for the axial gap motor 100 as the first embodiment of the invention shown in FIG. 4. Note that, in FIG. 5, the bobbin 8 is not shown for visibility of the drawing.

As shown in FIG. 5, the iron core pieces 1 are held by the resin material 4 and the conducting material 2. That is, the iron core pieces 1 are fixed to the case 3 by the resin material 4 and the conducting material 2. The resin material 4 is used for holding, and the weight of the stator 20A may be reduced. Further, the resin material 4 is used, and thereby, moldability and assemblability of the stator 20A become better. Thereby, the manufacturing cost of the stator 20A may be reduced. Furthermore, the manufacturing cost of the axial gap motor 100 using the stator 20A may be reduced.

On the other hand, regarding the iron core pieces 1, the iron core pieces 1 are not displaced in the axis direction (y-axis direction) of the shaft 50 by the conducting material 2. Further, grounding of the stator 20A and the rotors 30 is achieved by the conducting material 2. In addition, the conducting material 2 can also serve as a heat radiation material.

As the other effects, in the embodiment, the iron core pieces 1 are fixed by both the conducting material 2 and the resin material 4, and thereby, even when the resin material 4 is deteriorated, the iron core pieces 1 may be strongly held in desired positions and the iron core pieces 1 are not displaced. Accordingly, reliability in holding of the iron cores is improved. Further, even when the rigidity of the resin material 4 becomes lower due to heating or heat generation, the reduced holding force of the iron core pieces by the resin material 4 may be supplementarily complemented by the conducting material 2.

Generally, the resin material 4 is higher in unit price than the conducting material 2. In the embodiment, the usage of the resin material 4 necessary in related art may be reduced by the volume of the conducting material 2. Thereby, the embodiment may contribute to cost reduction.

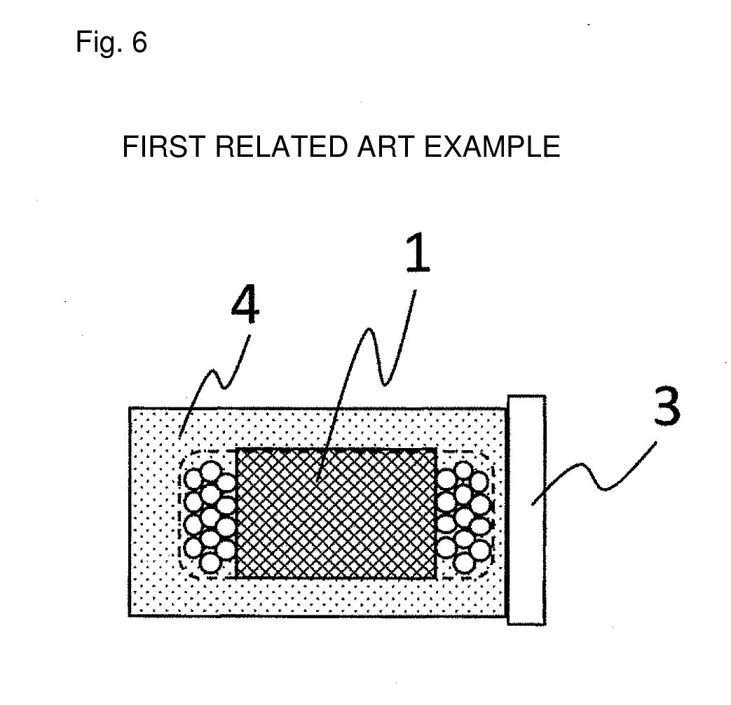

Next, an axial gap motor as a first related art example (e.g., PTL 1) and the axial gap motor 100 as the first embodiment of the invention will be compared using FIG. 6. FIG. 6 is a sectional view of the axial gap motor of the first related art example.

In the axial gap motor of the first related art example, the iron core pieces 1 are held by the insulating resin material 4, and thereby, the iron core pieces 1 have floating potentials. Accordingly, a potential difference is generated due to capacitance between the stator and the rotor. As a result, for example, micro discharge occurs in a location at a smaller insulation distance between the stator and the rotor or a location of a bearing with smaller capacitance or the like, and the bearing is damaged.

On the other hand, in the axial gap motor 100 as the first embodiment, grounding of the stator 20A and the rotors 30 is achieved by the conducting material 2 shown in FIG. 5. In addition, the conducting material 2 can also serve as a heat radiation material. The heat radiation of the conducting material 2 may be improved by increasing the contact area between the iron core pieces 1 and the case 3.

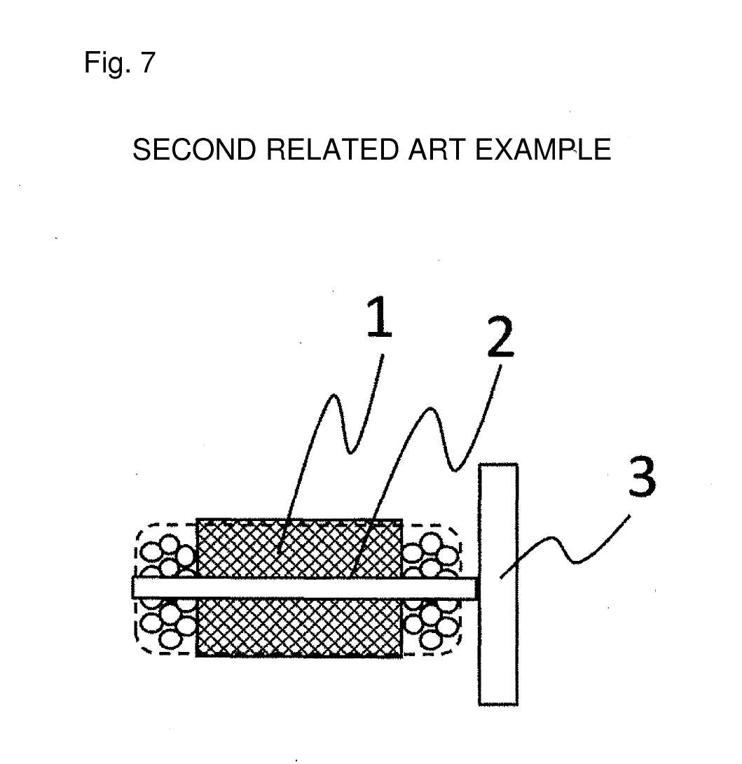

Next, an axial gap motor as a second related art example (e.g., PTL 2) and the axial gap motor as the first embodiment of the invention will be compared using FIG. 7. FIG. 7 is a sectional view of the axial gap motor of the second related art example.

In the axial gap motor of the second related art example, the iron core pieces 1 are held only by the conducting material 2. In the configuration, the usage of the conducting material 2 increases and the motor weight also increases. Further, the conducting material 2 penetrates the iron core pieces 1 in the radial direction and divides the coils in two, and the manufacture is complex.

On the other hand, in the axial gap motor 100 as the first embodiment, the conducting material 2 is in contact with the upper ends of the iron core pieces 1. Accordingly, it is not necessary to divide the coils 9 in two and the motor may be easily manufactured. Further, the iron core pieces 1 are strongly held by the resin material 4 and the conducting material 2. Furthermore, the weight of the motor may be reduced by the resin material 4.

As described above, according to the embodiment, the axial gap motor with higher reliability in which displacement of iron core pieces at temperature rise is prevented may be easily manufactured to be lighter.

### Second Embodiment

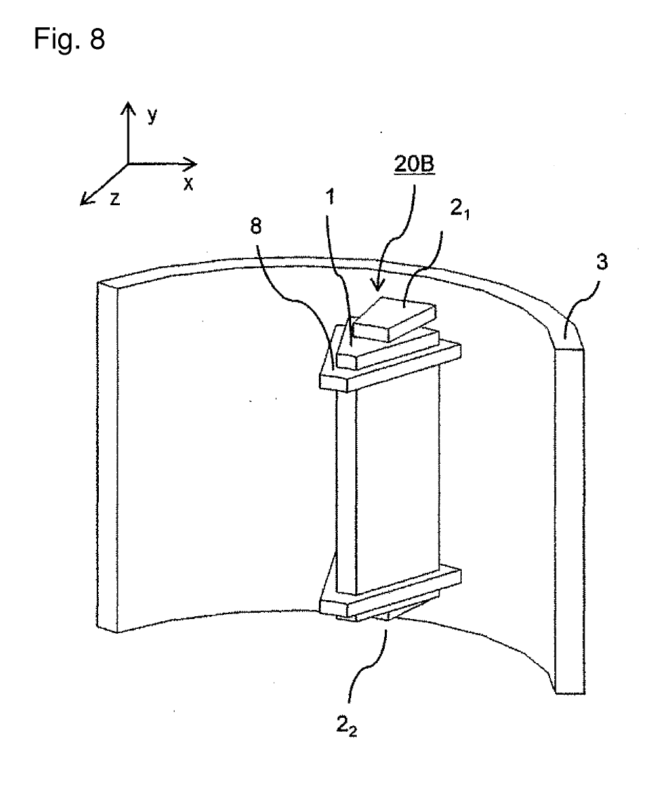

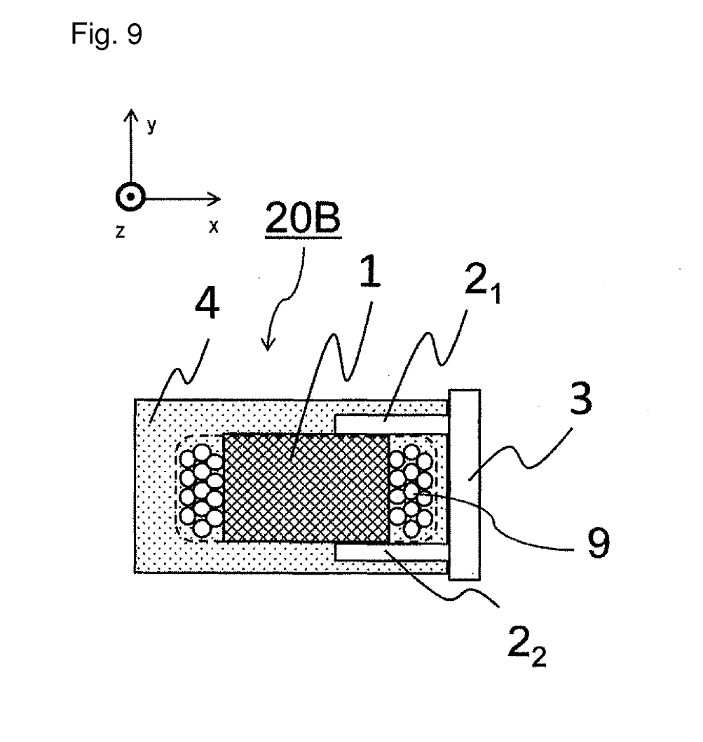

Next, a configuration of a stator 20B used for an axial gap motor 100 as the second embodiment of the invention will be explained using FIGS. 8 and 9. Note that the same signs are assigned to the same parts as those in FIGS. 1 to 5.

First, the configuration of the stator 20B will be explained in detail using FIG. 8. FIG. 8 is a configuration diagram of the stator 20B used for the axial gap motor 100 as the second embodiment of the invention. Note that, in FIG. 8, the resin material 4 and the coil 9 are not shown for visibility of the drawing.

The stator 20B of the embodiment is different compared to the stator 20A in FIG. 4 in that, in addition to the conducting material 2₁ in contact with the upper ends of the iron core pieces 1, a conducting material 2₂ in contact with the lower ends of the iron core pieces 1 is provided. That is, the iron core pieces 1 are sandwiched and fixed between the conducting material 2₁ and the conducting material 2₂. The conducting material 2₁ may be fixed to the upper ends of the iron core pieces 1 and the conducting material 2₂ may be fixed to the lower ends of the iron core pieces 1 by welding, pressure welding, or the like. The conducting material 2₁ and the conducting material 2₂ are pressure-welded to the case 3.

Next, the configuration of the stator 20B will be explained using FIG. 9. FIG. 9 is a sectional view of the stator 20B of the axial gap motor 100 as the first embodiment of the invention shown in FIG. 8. Note that, in FIG. 9, the bobbin 8 is not shown for visibility of the drawing.

The stator 20B is integrally molded using the resin material 4 to contain the iron core pieces 1, the coils 9 wound around the iron core pieces 1, the conducting material 2₁ in contact with the upper ends of the iron core pieces 1 and the conducting material 2₂ in contact with the lower ends of the iron core pieces 1 inside.

Regarding the iron core pieces 1, the iron core pieces 1 are not displaced in the axis directions (y-axis directions (+) and (−)) of the shaft 50 by the conducting material 2₁ and the conducting material 2₂.

Specifically, a force pulling the iron core pieces 1 in the axis direction acts due to the magnetic attraction force by the rotor 30, however, the conducting material 2 is provided in the position where the movements of the iron core pieces 1 in the axis direction are hindered, and the iron core pieces 1 may be held in the desired positions. As a result, the holding strength of the iron core pieces 1 is improved. Further, the embodiment is also effective for rigidity reduction of the conducting material 2 due to heating or heat generation.

As described above, according to the embodiment, the axial gap motor with higher reliability in which displacement of iron core pieces at temperature rise is prevented may be easily manufactured to be lighter.

### Third Embodiment

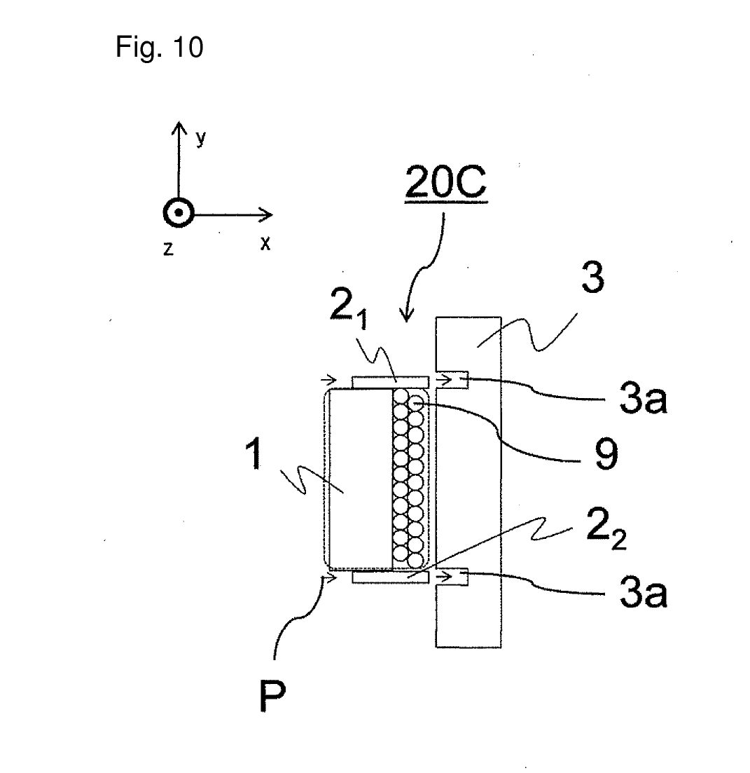

Next, a configuration of a stator 20C used for an axial gap motor 100 as the third embodiment of the invention will be explained using FIG. 10. FIG. 10 is a sectional view of the stator 20C used for the axial gap motor 100 as the third embodiment of the invention. Note that the same signs are assigned to the same parts as those in FIGS. 1 to 5. In FIG. 10, the resin material 4 and the bobbin 8 are not shown for visibility of the drawing.

The stator 20C of the embodiment is different compared to the stator 20B in FIG. 9 in that the case 3 includes a hole 3a in the inner circumferential surface. The conducting material 2₁ and the conducting material 2₂ are press-fitted into the hole 3a of the case 3.

In the embodiment, the conducting material 2 moving by the injection pressure P of the resin material 4 may be automatically inserted into the hole 3a provided in the case 3. The degree of freedom of the conducting material 2 inserted into the hole 3a is lower and the holding strength of the iron core pieces 1 is further improved.

Further, the bonding area between the conducting material 2 and the case 3 is larger and the structure is also advantageous in heat radiation. Furthermore, in the above described configuration, it is more preferable that the hole 3a provided in the case 3 where the hole 3a has a geometrically complicated shape.

As a result, it is harder to pull out the conducting material 2 from the case 3, and thereby, the holding strength of the iron core pieces 1 is further improved and the heat radiation area also increases. Furthermore, the process of attaching the conducting material 2 may be simplified, and the cost reduction may be achieved.

As described above, according to the embodiment, the axial gap motor with higher reliability in which displacement of iron core pieces at temperature rise is prevented may be easily manufactured to be lighter.

### Fourth Embodiment

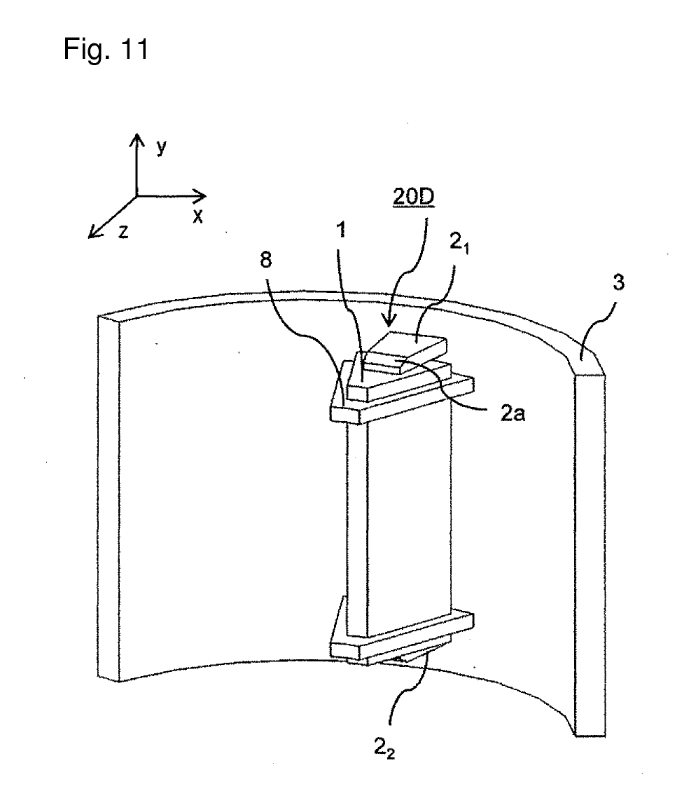

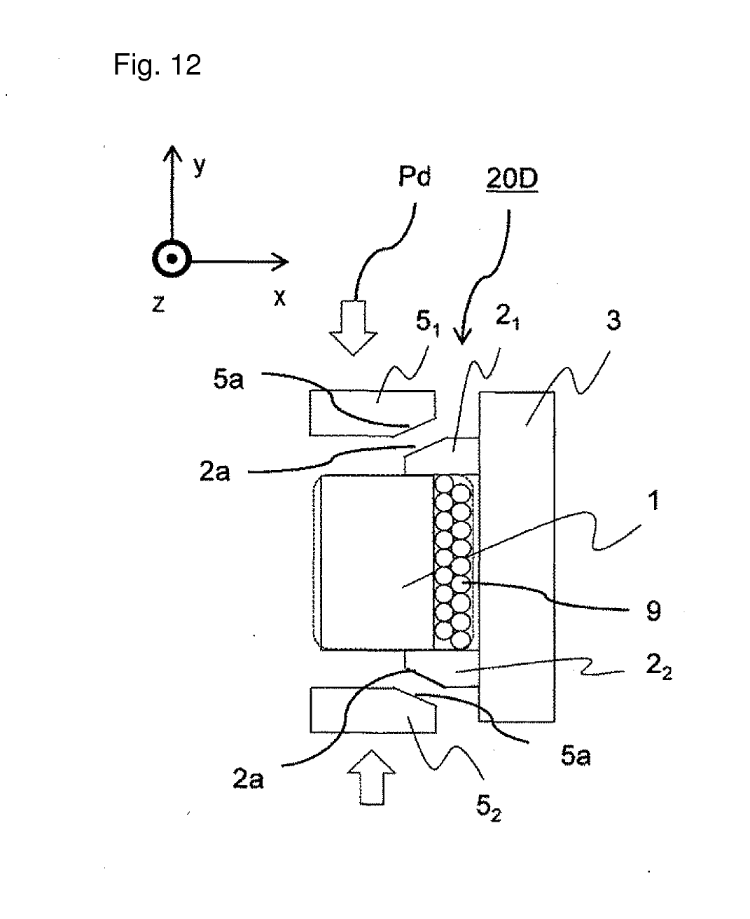

Next, a configuration of a stator 20D used for an axial gap motor 100 as the fourth embodiment of the invention will be explained using FIGS. 11 and 12. Note that the same signs are assigned to the same parts as those in FIGS. 1 to 5.

First, the configuration of the stator 20D will be explained in detail using FIG. 11. FIG. 11 is a configuration diagram of the stator 20D used for the axial gap motor 100 as the fourth embodiment of the invention. Note that, in FIG. 11, the resin material 4 and the coil 9 are not shown for visibility of the drawing.

The stator 20D of the embodiment is different compared to the stator 20B in FIG. 8 in that the plate-like conducting material 2 has a slope 2a. Specifically, the conducting material 2₁ has a slope 2a with a tilt of about 45° with respect to the bottom surface thereof. On the other hand, the conducting material 2₂ has a slope 2a with a tilt of about (−45)° with respect to the bottom surface thereof. The slope 2a is formed at the inner side in the radial direction of the conducting material 2.

Next, the configuration of the stator 20D will be explained using FIG. 12. FIG. 12 is a sectional view of the stator 20D used for the axial gap motor 100 as the fourth embodiment of the invention shown in FIG. 11. Note that, in FIG. 12, the resin material 4 and the bobbin 8 are not shown for visibility of the drawing.

The slope 2a of the conducting material 2 is formed to be in parallel to a slope formed in a die 5 (5₁, 5₂) when the resin material 4 is molded.

In the embodiment, the conducting material 2 is pressure-bonded and fixed to the case 3 by mold clamping pressure Pd at injection of the resin material 4 by the slope 2a. Specifically, when the stator 20D is molded, the slope 2a of the conducting material 2₁ and the slope 5a of the die 5₁ come into contact and the slope 2a of the conducting material 2₂ and the slope 5a of the die 5₂ come into contact. Under the condition, as shown in FIG. 12, when the mold clamping pressure Pd is applied in the y-axis directions (+) and (−), by their force components (in x-directions), the conducting materials 2₁ and 2₂ are pressed and pressure-welded to the case 3.

That is, to mold the resin material 4 in a predetermined shape, the die 5 or the like is used, and, when the injection pressure of the resin material 4 is larger, it is necessary to clamp the die 5 with a force equal to or more than the injection pressure.

As a result, the conducting material 2 is pressed against the iron core pieces 1 and the case 3 by that larger mold clamping pressure Pd, and the fixation strength between the iron core pieces 1 and the conducting material 2 or between the iron core pieces 1 and the case 3 after molding increases. Thereby, the holding strength of the iron core pieces 1 is improved. Further, the process of attaching the conducting material 2 may be simplified, and the cost reduction may be achieved.

As described above, according to the embodiment, the axial gap motor with higher reliability in which displacement of iron core pieces at temperature rise is prevented may be easily manufactured to be lighter.

### Fifth Embodiment

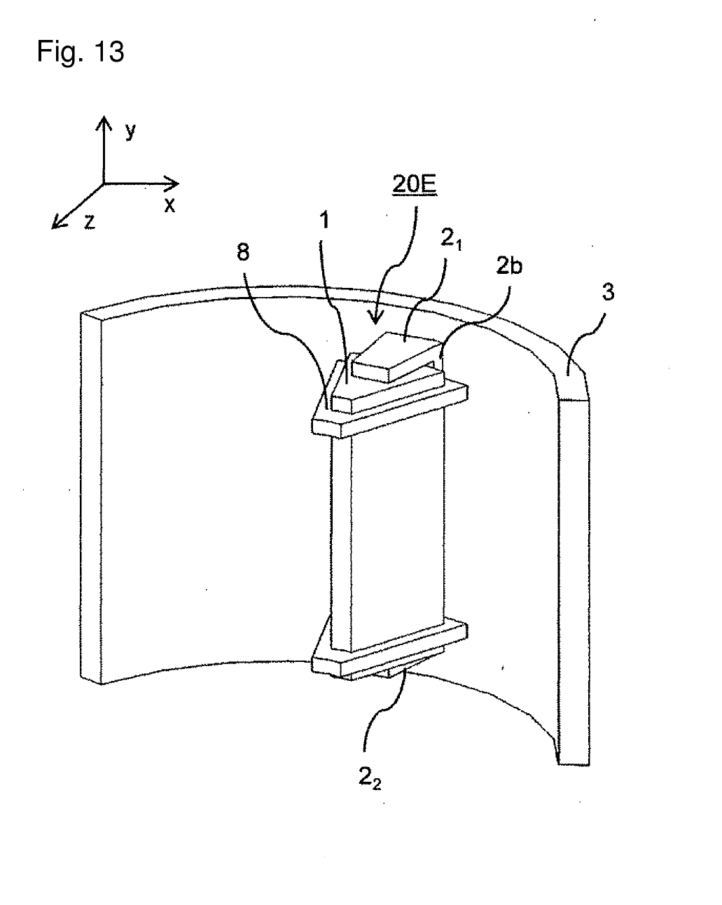

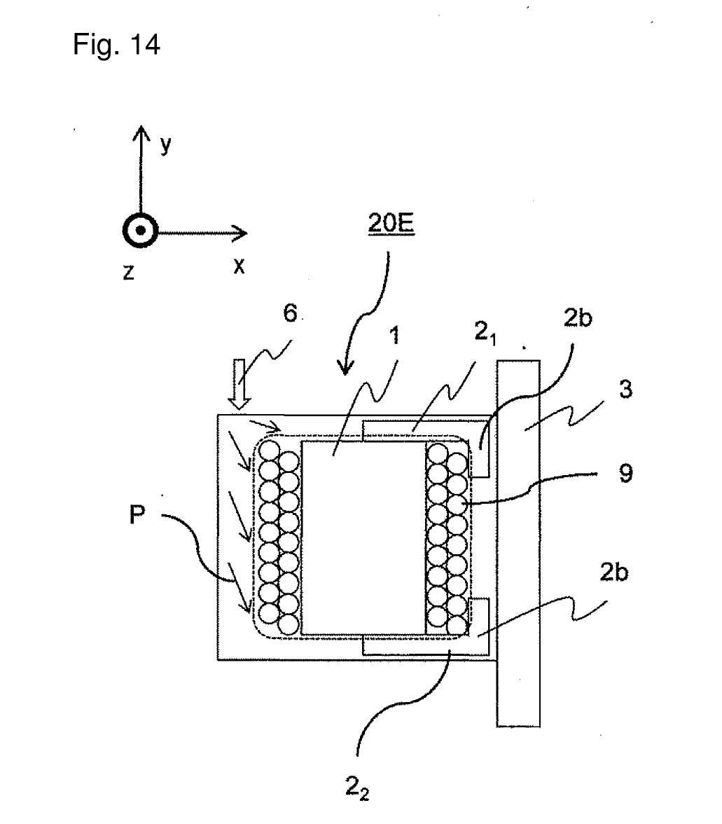

Next, a configuration of a stator 20E used for an axial gap motor 100 as the fifth embodiment of the invention will be explained using FIGS. 13 and 14. Note that the same signs are assigned to the same parts as those in FIGS. 1 to 5.

First, the configuration of the stator 20E will be explained in detail using FIG. 13. FIG. 13 is a configuration diagram of the stator 20E used for the axial gap motor 100 as the fifth embodiment of the invention. Note that, in FIG. 13, the resin material 4 and the coil 9 are not shown for visibility of the drawing.

The stator 20E of the embodiment is different compared to the stator 20B in FIG. 8 in that the conducting material 2 has a heat radiation part 2b in a flange shape.

Next, the configuration of the stator 20E will be explained using FIG. 14. FIG. 14 is a configuration diagram of the stator 20E used for the axial gap motor 100 as the fifth embodiment of the invention shown in FIG. 13. Note that, in FIG. 14, the bobbin 8 is not shown for visibility of the drawing.

The sectional view of the conducting material 2 is a nearly L-shape. The heat radiation part 2b of the conducting material 2 is fixed to the case 3. Here, the conducting material 2 is pressed and pressure-welded to the case 3 by injection pressure P when the resin material 4 is injected.

In the embodiment, the conducting material 2 is provided in the position different from an injection port 6 of the resin material 4. As a result, by the injection of the resin material 4, larger compression stress is generated in the iron core pieces 1 and the pressure in the locations different from the injection port is smaller, and thereby, the iron core pieces 1 are displaced toward the case 3. Note that, in FIG. 14, the injection pressure P of the resin material 4 is shown by an arrow.

As a result, the heat radiation part 2b of the conducting material 2 provided between the case 3 and the iron core piece 1 is pressed against the case 3 and the fixation strength between the iron core piece 1 and the conducting material 2 or between the conducting material 2 and the case 3 is improved. Consequently, the iron core pieces 1 may be strongly fixed and held.

As described above, according to the embodiment, the axial gap motor with higher reliability in which displacement of iron core pieces at temperature rise is prevented may be easily manufactured to be lighter.

### Sixth Embodiment

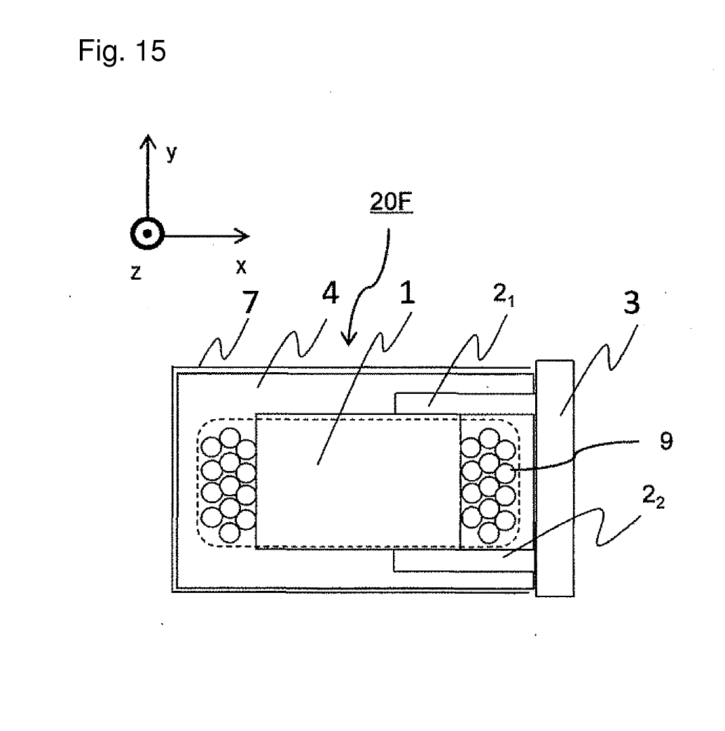

Next, a configuration of a stator 20F used for an axial gap motor 100 as the sixth embodiment of the invention will be explained using FIG. 15. FIG. 15 is a sectional view of the stator 20F used for the axial gap motor 100 as the sixth embodiment of the invention. Note that the same signs are assigned to the same parts as those in FIGS. 1 to 5. In FIG. 15, the bobbin 8 is not shown for visibility of the drawing.

The stator 20F of the embodiment is different compared to the stator 20B in FIG. 9 in that the outer circumference of the resin material 4 is covered by PTFE (polytetrafluoroethylene) 7 as a release agent.

Specifically, the PTFE 7 is applied to the other surfaces than the surfaces to which the case 3 and the resin material 4 are bonded. The resin material 4 is cured under a condition that the iron core pieces 1 and the conducting material 2 are grounded. In place of application of PTFE 7, a material having good releasability (e.g., polyimide film) may be provided.

In the embodiment, the resin material 4 in the locations in contact with the PTFE 7 is easily released from the bonding surface. On the other hand, the releasability is worse on the bonding surface to the case 3, and the resin material 4 is attracted toward the case 3 and contracts and becomes hardened by the contraction pressure at curing of the resin material 4. In this case, the resin material 4 attracts the iron core pieces 1 and the conducting material 2 together toward the case 3. Accordingly, the iron core pieces 1 and the conducting material 2 are strongly held and, as a result, the holding strength of the iron core pieces 1 is improved.

As described above, according to the embodiment, the axial gap motor with higher reliability in which displacement of iron core pieces at temperature rise is prevented may be easily manufactured to be lighter.

### Seventh Embodiment

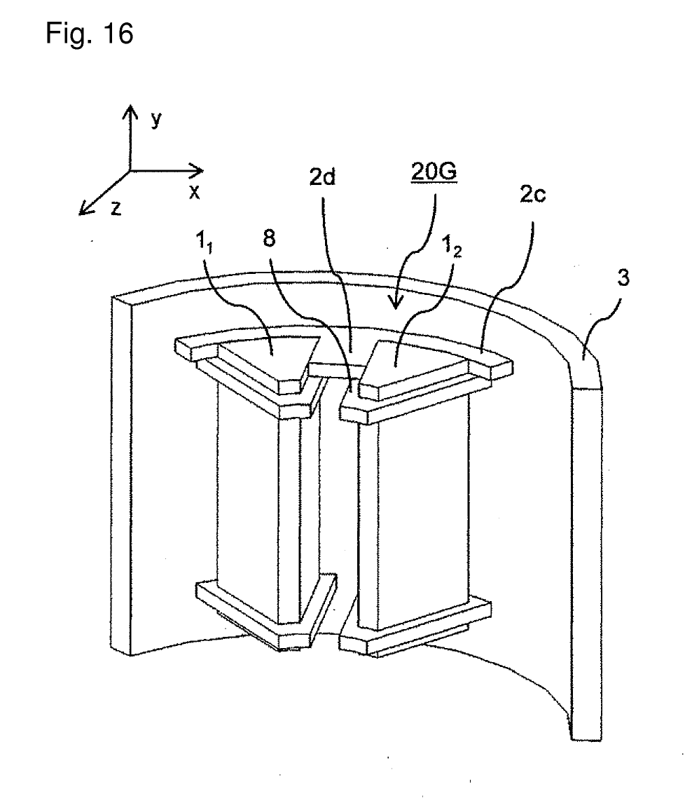

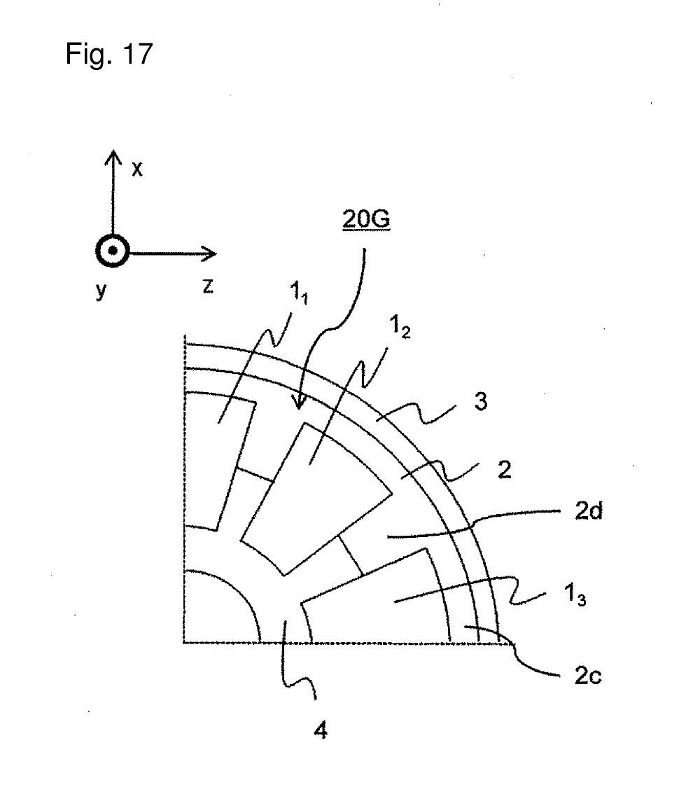

Next, a configuration of a stator 20G used for an axial gap motor 100 as the seventh embodiment of the invention will be explained using FIGS. 16 and 17. Note that the same signs are assigned to the same parts as those in FIGS. 1 to 5.

First, the configuration of the stator 20G will be explained in detail using FIG. 16. FIG. 16 is a configuration diagram of the stator 20G used for the axial gap motor 100 as the seventh embodiment of the invention. Note that, in FIG. 16, the resin material 4 and the coils 9 are not shown for visibility of the drawing.

The stator 20G of the embodiment is different compared to the stator 20B in FIG. 8 in that the conducting material 2 has an annular part 2c and a convex part 2d. The annular part 2c is provided between the iron core pieces 1 and the case 3 to be in contact with the upper ends of the iron core pieces 1 and the inner circumferential surface of the case 3. The convex part 2d is provided between the upper ends of these iron core pieces 1 to be in contact with the upper ends of the adjacent iron core pieces 1. The upper parts (end parts) of the iron core pieces 1 are press-fitted into a part surrounded by the annular part 2c and the convex part 2d or otherwise, the conducting material 2 is fixed to the iron core pieces 1. The conducting material 2 is press-welded to the case 3.

The upper end surface of the conducting material 2 and the upper end surfaces of the iron core pieces 1 are provided on the same plane. The conducting material 2 is manufactured by punching of a plate-like material (aluminum or the like).

Next, the configuration of the stator 20G will be explained using FIG. 17. FIG. 17 is a top view of the stator 20G used for the axial gap motor 100 as the seventh embodiment of the invention shown in FIG. 16.

Here, when the rotors 30 of the axial gap motor 100 rotate, a force acts on the iron core pieces 1 along the circumferential direction of the rotation axis. In the embodiment, the convex part 2d of the conducting material 2 is provided to hinder the movements of the iron core pieces 1 in the circumferential direction. Accordingly, the iron core pieces 1 may be held in desired positions. As a result, the holding strength of the iron core pieces 1 is improved. Further, the embodiment is also effective for rigidity reduction of the resin material 4 due to heating or heat generation.

As described above, according to the embodiment, the axial gap motor with higher reliability in which displacement of iron core pieces at temperature rise is prevented may be easily manufactured to be lighter.

### Eighth Embodiment

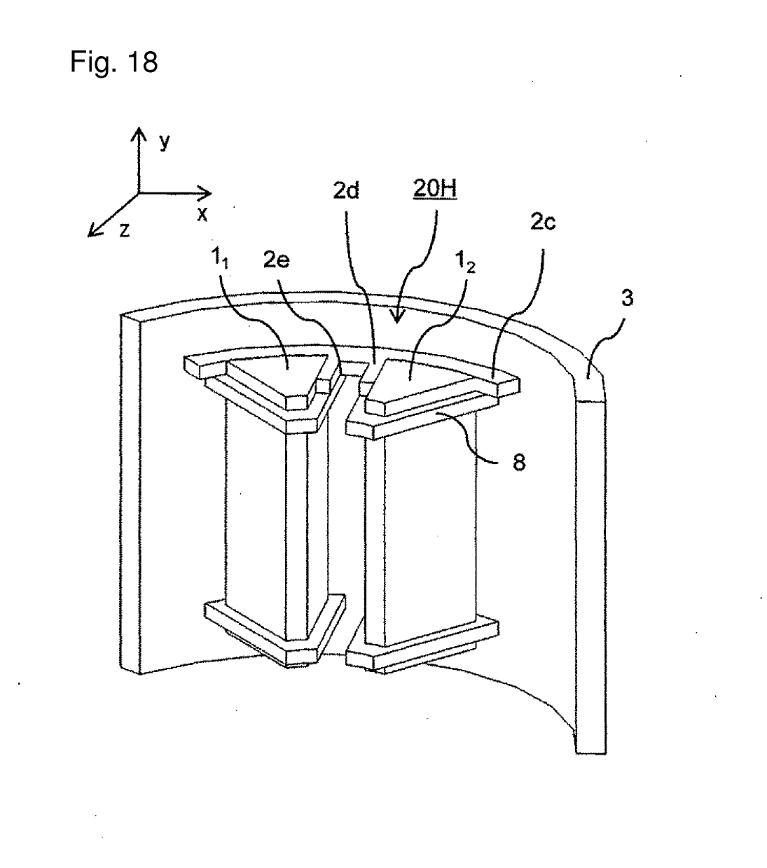

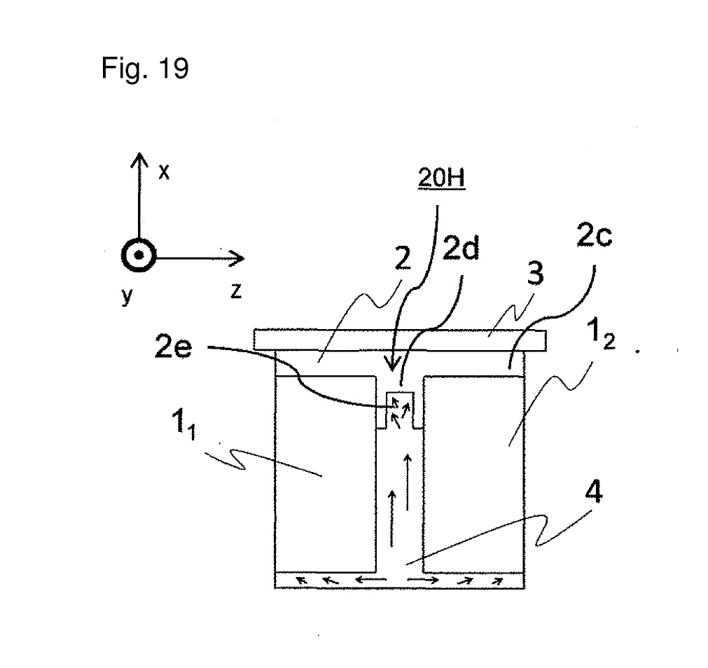

Next, a configuration of a stator 20H used for an axial gap motor 100 as the eighth embodiment of the invention will be explained using FIGS. 18 and 19. Note that the same signs are assigned to the same parts as those in FIGS. 1 to 5.

First, the configuration of the stator 20H will be explained in detail using FIG. 18. FIG. 18 is a configuration diagram of the stator 20H used for the axial gap motor 100 as the eighth embodiment of the invention. Note that, in FIG. 18, the resin material 4 and the coils 9 are not shown for visibility of the drawing.

The stator 20H of the embodiment is different compared to the stator 20G in FIG. 16 in that the convex part 2d of the conducting material 2 has a cutout part 2e.

Next, the configuration of the stator 20H will be explained using FIG. 19. FIG. 19 is a top view (schematic view) of the stator 20H used for the axial gap motor 100 as the eighth embodiment of the invention shown in FIG. 18.

In the embodiment, as shown by an arrow in FIG. 19, compression stress acts on the conducting material 2 and the iron core pieces 1 by the flow of the injected resin material 4. Accordingly, the iron core pieces 1 and the conducting material 2 may be pressed against the case 3. Specifically, on the cutout part 2e formed in the convex part 2d of the conducting material 2, the compression stress acts to open the cutout part 2e. As a result, the fixation strength between the iron core piece 1 and the conducting material 2 or between the conducting material 2 and the case 3 is improved. Thereby, the iron core pieces 1 may be strongly fixed and held.

As described above, according to the embodiment, the axial gap motor with higher reliability in which displacement of iron core pieces at temperature rise is prevented may be easily manufactured to be lighter.

The invention is not limited to the above described examples, but includes various modified examples. For example, the above described examples are explained in detail for clear explanation of the invention, but not necessarily limited to those including all of the explained configurations. Part of the configuration of an example may be replaced by the configuration of another example, and the configuration of an example may be added to the configuration of another example. With respect to part of the configuration of each example, addition, deletion, and replacement of other configurations may be performed.

### REFERENCE SIGNS LIST

1 . . . iron core piece
2 . . . conducting material
2a . . . slope
2b . . . heat radiation part
2c . . . annular part
2d . . . convex part
2e . . . cutout part
3 . . . case (housing)
4 . . . resin material
5 . . . die
6 . . . injection port (resin material injection part)
7 . . . PTFE (release agent)
8 . . . bobbin
9 . . . coil
20 . . . stator
30 . . . rotor
31 . . . structure member
32 . . . yoke
33 . . . permanent magnet
50 . . . shaft
60 . . . bearing

1. An axial gap motor comprising:
a rotor;
a stator in which a plurality of iron core pieces wound with coils are arranged in a circumferential direction;
a case housing the rotor and the stator,
wherein the stator and the rotor are coaxially provided with an air gap in between,
the stator has a conducting material provided to be in contact with end parts of the iron core pieces in an axis direction and fixed to the case, and is integrally molded using a resin material to contain the coils, the iron core pieces, and the conducting material inside, and thereby, fixed to the case.

2. The axial gap motor according to claim 1, wherein the conducting material is provided to be in contact with both ends of the iron core pieces in the axis direction.

3. The axial gap motor according to claim 2, wherein the case has a hole in an inner circumferential surface thereof, and
the conducting material is press-fitted into the hole.

4. The axial gap motor according to claim 2, wherein the conducting material has a slope, and
the slope is formed to be in parallel to a slope formed in a die used when the stator is molded using the resin material.

5. The axial gap motor according to claim 2, wherein the conducting material has a heat radiation part in a flange shape.

6. The axial gap motor according to claim 2, wherein the resin material is covered by a release agent and cured.

7. The axial gap motor according to claim 1, wherein the conducting material has an annular part and a convex part,
the annular part is provided between the iron core pieces and the case to be in contact with the iron core pieces and the case, and
the convex part is provided between upper ends of these iron core pieces to be in contact with the upper ends of the adjacent iron core pieces.

8. The axial gap motor according to claim 7, wherein the convex part has a cutout.
